(19) United States
(12) Patent Application Publication
(10) Pub. No.: US 2006/0183505 A1
(43) Pub. Date: Aug. 17, 2006

(54) Digital mobile planner

(75) Inventor: Candace Yvette Willrich, Grand Prairie, TX (US)

Correspondence Address: BAY AREA INTELLECTUAL PROPERTY GROUP, LLC, PO BOX 210459, SAN FRANCISCO, CA, 94121-0459, US

(73) Assignee: Willrich Scott Consulting Group, Inc., Redwood City, CA (US)

(21) Appl. No.: 11/353,654

(22) Filed: Feb. 13, 2006

Related U.S. Application Data
(60) Provisional application No. 60/653,199, filed on Feb. 15, 2005.

(51) Int. Cl. H04B 1/38; H04M 1/00

(52) U.S. Cl. 455/566

(57) ABSTRACT

A handheld electronic device (201) is provided. The device comprises (a) first (207) and second (209) displays; (b) a first processor adapted to run an operating system on the first display; and (c) a second processor capable of executing an operating system on the second display independently of the first processor.

### CROSS-REFERENCE TO RELATED APPLICATIONS

The present Utility patent application claims priority benefit of the U.S. provisional application for patent number U.S. 60/653,199 filed on Feb. 15, 2005 under 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to electronic devices. More particularly, the invention relates to electronic devices with multiple processors and/or multiple displays.

### BACKGROUND OF THE INVENTION

A variety of Personal Digital Assistants (PDAs) and other compact or handheld electronic devices are known to the art. As these devices have evolved, users have come to expect these devices to have increasingly greater functionalities. For example, without limitations many current PDAs are adapted to run special versions of the same operating systems that are used on laptop and desktop computers.

One of the problems encountered in adding functionality to handheld devices is the smaller surface area available for input/output. In order to compensate for this shortcoming, some handheld devices have been designed which feature a dual display. FIG. 1 illustrates an exemplary prior art gaming device with two displays. A device 101 is equipped with a first display 103 and a second display 105. Displays 103 and 105 are both backlit color LCD displays. Second display 105 is touch sensitive, and may be operated upon with a stylus 107. Device 101 has various other features and accessories, including stereo speakers 109, a power button 111, control buttons 113, a built-in microphone 115, a disk drive 117, headphone/microphone connectors 119, and LED lights 121 to indicate power or battery recharge status. One example of such a device is the Nintendo DS® gaming device available from the Nintendo Corporation and depicted in FIG. 1. This device is equipped with two backlit, color LCD displays. The second display is touch sensitive, and may be operated upon with a stylus.

While devices such as, but not limited to, the gaming device illustrated in FIG. 1 have many desirable attributes, they also have certain shortcomings. For example, without limitation, the device of FIG. 1 is a dedicated gaming device, and hence is not usable as a general computer device or PDA for running word processing software and other such general-purpose programs.

A number of PDAs and other such devices are available that are suitable for use as general computer devices. However, the operating systems of these devices are often prone to stalling or crashing. This frequently happens, for example, without limitation, when a particular task consumes most or all available processing power for a prolonged period of time, or when an application malfunctions. In such cases, other operations being handled by the processor must often wait until the situation is rectified, thus causing the device to become non-responsive. In many cases, the device must be restarted or reset, and in extreme cases, it may even be necessary to reinstall the operating system in the device. One example, without limitations of a common task that frequently causes PDAs and other such devices to become non-responsive is the synchronization of the device with another computer, due to the intense demand that this type of operation can place on the processor.

Current technology for mobile planning devices include, but are not limited to, paper planners, tablet PCs, and laptop PCs. These devices have many limitations including, but not limited to, the limitations listed below. Paper planners are full of paper, and paper forms must be refilled and/or ordered. Paper planners often include many unused sections, and can often appear cluttered and unorganized. Paper can be pulled from paper planners causing it to be easily torn and damaged. Also, pen notes cannot be erased from paper planners. Paper planners have limited space available for writing needed notes, and notes are not attached to a contact's name. There is also no search available on paper planners, and paper planners provide limited integration with other devices such as, but not limited to, personal digital assistants, cellular phones and desktop solutions such as, but not limited to, knowledge management and database applications. Also, paper planners are not secure; they do not lock.

Tablet PCs are bulky, large, heavy, and take up significant desk space. Tablet PCs do not have a cover, are open, and appear less secure, although some tablets come packaged as a laptop. Tablets PC do not include paper. Also, with tablet PCs, the keyboard is an extra piece of equipment that must be carried with the tablet PC. The tablet docking station is bulky. Most users prefer laptops. DVD/CD is typically a peripheral device to the display device or built-into keyboard section. Also, tablet PCs are not secure, and have no locks.

Laptop PCs are bulky, large, heavy, and take up significant desk space. Laptops are still not secure; they do not come with locks. Laptops have only one viewing area. A writing option is not included in laptop PCs. Also, paper is not included with a laptop.

There is thus a need in the art for a device that overcomes the aforementioned infirmities. In particular, there is a need in the art for a PDA or other electronic device, of the handheld variety or otherwise, with increased input/output area. There is also a need in the art for such a device that is capable of multitasking, and that is impervious to stalling or crashing during events that consume large amounts of available processing power. These and other needs are met by the devices and methodologies disclosed herein and hereinafter described.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary prior art gaming device having dual displays;

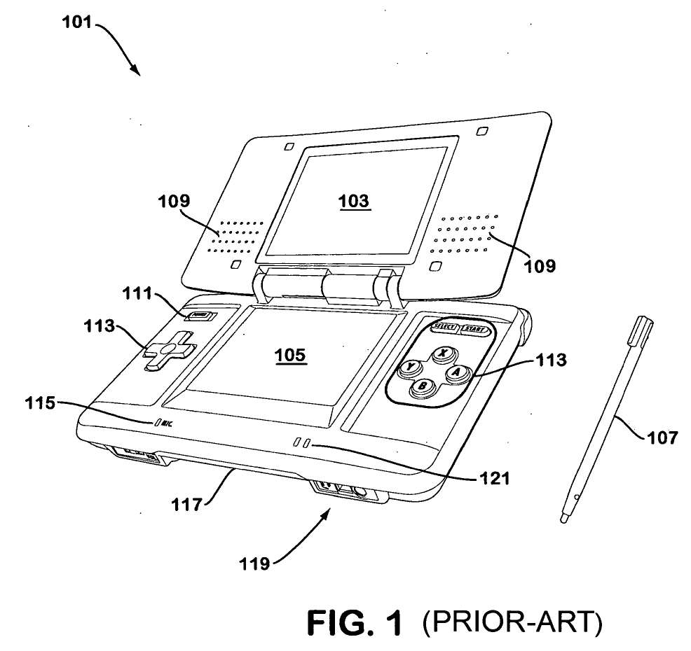

FIGS. 2-4 illustrate an exemplary digital mobile device with multiple displays, in accordance with an embodiment of the present invention. FIG. 2 illustrates the device in an open configurations, showing a first display and a second display. FIG. 3 shows the device in an open configuration with the second display functioning as a virtual keyboard. FIG. 4 shows the device in a closed configuration;

FIG. 5 illustrates exemplary multi-display devices that are implemented in a tri-fold configuration, in accordance with an embodiment of the present invention;

FIG. 6 illustrates exemplary mobile multi-display devices that are designed for writing, viewing data, and using a cellular phone, in accordance with embodiments of the present invention;

FIG. 7 illustrates an exemplary television implemented with one or more auxiliary viewers or displays, in accordance with an embodiment of the present invention;

FIG. 8 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of digital mobile planner devices and techniques are described.

In one embodiment, a handheld electronic device is provided which comprises first and second displays; a first processor adapted to run an operating system on said first display; and a second processor adapted to run an operating system on said second display independently of said first processor. In some embodiments, the two processors may be in open communication with each other, and may cooperate with each other to perform various tasks. Means and method steps are also taught, which, in one aspect, implement a muli-processor and multi-display system.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

Particular embodiments of the present invention provide a device having two or more independent processors. The device is preferably in the form of a Personal Digital Assistant (PDA) or other handheld electronic device. The provision of multiple processors allows the device to perform computationally intensive operations, such as, but not limited to, synchronization of the device with another computer, without interrupting the performance of other tasks by the device and without causing the device to become non-responsive. By contrast, conventional PDAs and other handheld electronic devices utilize a single main processor and a multi-tasking operating system and, consequently, are prone to becoming non-responsive during computationally intensive operations. Moreover, the provision of multiple processors in embodiments of the invention described herein allows the device to run separate programs on separate displays, without operational difficulties in one of the processors affecting the operation of the other processor.

Devices can be made in accordance with the teachings herein that have multiple independent processors that preferably communicate with one another and are adapted to share information via a digital interface. In particular embodiments, each processor is equipped with its own input/output device(s), from which the processor can be dispatched to perform independent functions or operations. In many embodiments, these independent processors have separate instances of the same or different operating systems running, although, an alternative embodiment includes one operating system with one or more independent processors operating across multiple displays. Due to the ability of these devices to assign computationally intensive operations to one of the processors while keeping the other processor(s) available for use by the user, devices of this type are much less likely to become non-responsive during a computationally intensive event.

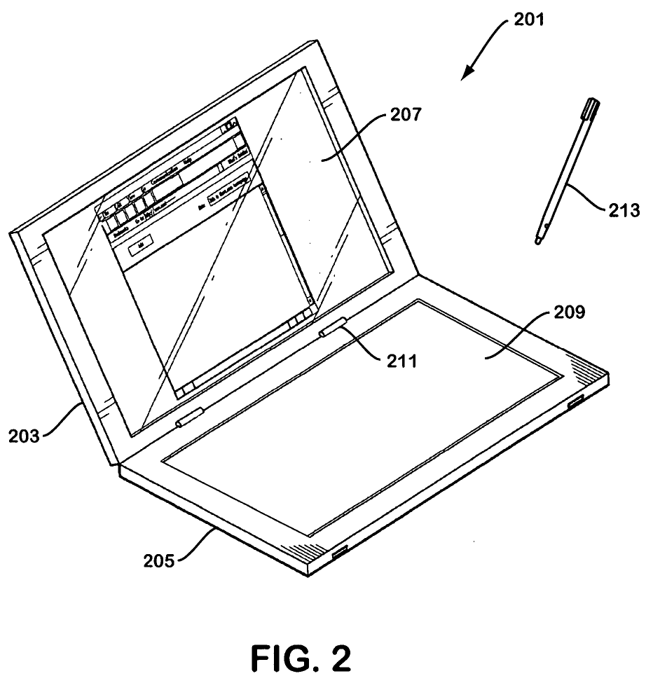

FIGS. 2-4 illustrate an exemplary digital mobile device 201 with multiple displays, in accordance with an embodiment of the present invention. FIG. 2 illustrates device 201 in an open configuration, showing a first display 207 and a second display 209. FIG. 3 shows device 201 in an open configuration with second display 209 functioning as a virtual keyboard. FIG. 4 shows device 201 in a closed configuration. In the present embodiment, device 201 comprises a first panel 203 and a second panel 205 equipped with first display 207 and second display 209, respectively, and joined together in a foldable manner along an axis by a plurality of hinges 211. The preferred embodiment opens and closes similar to a book along the major axis. However, in other embodiments, the device may be configured differently for example, without limitation, device 201 may hinge on the minor axis, have multiple hinges, have sides of differing sizes, or not hinge at all.

In the particular embodiment illustrated, a stylus 213 is provided to aid with input operations. It will be appreciated, however, that various other input/output devices may be utilized with device 201 as are known to the art, including, but not limited to, keyboards, mice, cameras, voice or character recognition devices, scanners, etc. These input/output devices may attach to, or may be housed within or in communication with, any of the panels. The preferred embodiment includes standard interfaces between the equipment. For example, without limitation, the displays 207 and 209 should be able to accept input means such as, but not limited to, mouse, pen, stylus, buttons, remote, and touch input for actions such as, but not limited to, making menu selections on device 201. In some embodiments if a mouse is included, the mouse may be built-in or detachable, and, in some embodiments, a wireless mouse may be used with the device. An optional display remote can be included using the built-in/pull-off method, or the remote can be completely detached. A display remote being defined as a remote with a display located on the remote any number of places. Some embodiments may include a built-in headset and microphone clip wherein both the headset and the microphone can be retractable, or optionally, both can be stored in a compartment located any number of places on the device. The headset can comprise a speaker, volume control, a microphone, a microprocessor, and other circuitry and can allow the user to use applications such as, but not limited to, radio, news applications, and voice over IP. The built-in microphone clip could possibly be interchangeable with the built-in headset. Also, the microphone can take any number of shapes and sizes; for example, without limitation, in some embodiments, the microphone can be pulled out from the device to resemble a normal microphone. Some embodiments may also include options that may be attached or detached from the device such as, but not limited to, power cables or USB cables.

Stylus 213 uses common writing functionality including, but not limited to, executing programs by selection with the stylus tip. The pen and stylus can be one device or two separate devices, which will be referred to as the stylus throughout this description. Advanced writing techniques can be applied including, but not limited to, the ability to switch easily from being a pen or a stylus, having mouse-like functionality, the ability to select paragraphs of text, the ability to write in multiple colors and have eraser functionality, the ability to change color via software on the writing device, the ability to function as a marker. Other features that may be available include, without limitation, tapping twice to select data, the ability to copy, paste, cut, and perform other similar functions, the ability to initiate saves to documents, pressing a button to switch between colors, pressing a button to switch between pen and stylus functionality, pen and pencil functionality, the ability to function as a pointer with a light for presentations, and the ability to drag and drop items on the writing surface. Stylus 213 can use various tip sizes by pressing a button on device 201. Optionally, the stylus tip can be detached and replaced with another size. The stylus can also optionally be switched to a pen or an eraser by turning the device over.

Stylus 213 can easily write or be used on either display without pressing any buttons even if both devices are being used as independent devices. This technique is extremely useful if two or more computing devices are being used simultaneously. Stylus 213 can switch colors dynamically. For example, without limitation, device 201 knows that in one application the color red should be used and knows that the color blue should be used in another one. This method can be applied to objects or sections of a single application such as, but not limited to, a document, spreadsheet, or database, and this technique works across dual displays. In some embodiments stylus 213 can transform into a scanning device where text from paper documents can be scanned into stylus 213 and dropped onto device 201. Stylus 213 can record the writing stroke as stylus 213 is used, and the data can then be transferred into a computing tool for conversion and interpretation. Stylus can comprise a microprocessor, memory, a storage area, and other circuitry. Stylus 213 can exchange files with other devices and electronics much like a flash-drive. Action buttons on the pen device can be preprogrammed to perform functions or execute a program for example, without limitation, turn audio on/off, open explorer on a display, secure device 201, mute device, run application, etc. Stylus 213 can have any number of action buttons located on stylus 213, or the action buttons can be toggled by pressing a button on stylus 213. Action buttons commands can easily be changed via software installed on device 201.

In some embodiments stylus 213 has a sensor that communicates with any of the displays and can serve as a remote control, a radio, an audio speaker, a microphone, or an intelligent agent. Stylus 213 switches between these states via a button on device 201 or on stylus 213 itself. An intelligent agent means that stylus 213 can serve as an alert medium, for example, without limitation, to alert the user to email, to provides status on a process, or to interact with a phone, etc. Stylus 213 can beep, voice a sound, or a word, or provide visual indicators such as, but not limited to, color-coded messages, to alert the user. Stylus 213 can scroll through a document or a presentation by using buttons on stylus 213. For instance, without limitation, a button can be pressed, and the presentation is scrolled to the next slide. Device 201 optionally has multiple stylus holding areas, for example, without limitation, one on each display unit. Also, the stylus size can adjust to fit on device 201 by contracting or expanding.

Panels 203 and 205 may be equipped with storage space for storing any attachable or detachable component including a keyboard, or portions thereof. Thus, in one embodiment of a two-panel device made in accordance with the teachings herein, a portion of a keyboard is stored in each panel, and the portions may be extracted and assembled into a full keyboard by the user. In some embodiments, the portions of the keyboard are configured so that they slide together and attach to each other when the panels are at a desired orientation with respect to each other, for example, without limitation, when the two panels are arranged in parallel. In some embodiments of the devices described herein, the keyboard may also be in the form of a flexible, touch-sensitive pad. This pad may be stored within one or both panels, may be stored between the panels, or may form part of a protective cover, which fits over the device or a portion thereof. A regular full-size keyboard can be used with device 201 communicating with device 201 wirelessly or by cable.

Some embodiments may include a digital keyboard or keypad that is almost as flat as a mouse pad. All of the keys are digitized on the pad, and the keypad fits in a compartment in the case or in device 201. Some embodiments may include digital function keys or buttons with digitized messages on the buttons for example, without limitation, color or words. A digital flat keypunch device, similar to the digital keypad, for keypunching data may also be available. An alternate embodiment for a keyboard comprises a display that lifts off of a hidden keyboard, keypad, or a digital keyboard. The display is shifted towards the second display and fits snugly on top of the other display, or the display can be placed beneath the keyboard. Another option is for the keyboard to lift off of the display and fold back so that it can be placed beneath the display. In other embodiments one display can flip into a keyboard or otherwise using a number of methods such as, but not limited to, embedded keys or keys that expand or inflate. Still, in other embodiments, one of the displays can flip over to reveal a keyboard, and then can flip back to reveal the display when needed. This particular embodiment can be designed any number of ways.

The keyboard, regardless of the type of keyboard, can interact with both display units of device 201 simultaneously or one at a time. Displays 207 and 209 can communicate with the keyboard and device 201 via USB, wirelessly, or any number of other common methods, and buttons situated on device 201 or on the keyboard, control how device 201 interacts with the keyboard. The keyboard may have hidden a compartment. The hidden compartment may be opened in any number of ways, and items can be stored in the compartment including, but not limited to headsets, storage media, etc. When one display turns into a keyboard, the remaining display can control any application running on either display.

A keyboard can also transform into a writing display for a pen, stylus, or other writing device. Any keyboard can have a writing display attached or detached. The writing display is a small writing pad that includes, without limitation, a pen, stylus, or any number of other pen devices. Any audio feature can be made available on any of these keyboards such as, but not limited to, volume control, mute, recording features, and speakers. Any keyboard for any embodiment can contain many features such as, but not limited to, USB slots, audio features, speakers, headsets, digitized function keys and buttons, and an extra set of buttons for preprogramming actions, such as, but not limited to, starting applications, opening documents, opening email, or even starting the device. The keyboard may also include a button that can turn on a light that illuminates the entire keyboard so that the user can type in the dark. The light and button can be added inside the housing of a CPU. Extra buttons may be placed at the top or the bottom of the keyboard. The keyboard may also optionally have a secondary mini-display area. Other computing devices can have a small writing display attached or detached as well, including laptops and other electronics.

External features that may be available on device 201 include, but are not limited to, a power on/off button, printer power ports, networking ports, action buttons, rotator buttons, up/down arrows to scroll through data, an antenna/WIFI, an extra display area for a calculator, a built-in modem and port, an extra display area for a customized menu, a disconnect button, indicator light buttons, and a release button for detachment. The device may also have a slot for digital media cards for storage such as, but not limited to, digital cards that resemble credit cards, smart media cards, etc. Action buttons are small buttons on display frame that can be programmed by the user. These buttons can light up with text, data, or colors. They can be used for actions such as, but not limited to, viewing and browsing data, making selections from any menu, checking for email, recording, starting camera functionality, controlling brightness of display, or running customized routines. Both display units of device 201 have action buttons available. Action buttons may be digitized. The digital text on a set of digital action keys is dynamic; it can vary according to the program being executed. Rotator buttons are small knob-like buttons to rotate through data. The power on/off button has the ability to turn one or both display units of device 201 on or off. Buttons and mouse functionality can be used to control applications on either display unit of device 201. Traditional indicator lights such as, but not limited to, on/off, caps lock, num locks, battery, and keyboard may be positioned on the display frame. The exterior of device 201 may also include any number of ports or slots for additional equipment to be attached to device 201 such as, but not limited to ports for battery chargers, headsets, cellular phonies, or PDAs.

As shown in FIG. 4, when device 201 is not in use, it may be folded into a closed configuration, and may be secured in that configuration by means of a latch or other suitable device. The latch may incorporate various security features, and may require the use of an instrument such as, but not limited to, a lock, a key, a remote control, a timed sensor, a RFID tag, or another tool to open device 201. RFID tags can be used to track device 201 by emitting a continuous signal. One purpose of a RFID sensor is to locate device 201 if stolen, lost, etc, and software can periodically check the location of device 201. A small GPS device that emits a signal may also be used in some embodiments to track device 201. This tracking device can contain information including, but not limited to, corporate name, address, serial numbers, etc. The tracking device may be designed to emit a signal all of the time with location information. The GPS device can take on any number of shapes, sizes, and designs, including without limitation, an internal computing component such as a chip or a set of circuits, an external adapter that plugs into a port on the device, or a card insert device that can slide into a PCMCIA slot.

Remotes can also be used to find or locate device 201 if device 201 is equipped with a location sensor. In some embodiments, the latch may also require the provision of various biometrics, such as, but not limited to, a retinal scan or fingerprint scan, in order for it to be opened. In embodiments that include a remote, the remote can optionally come with a display for functions such as, but not limited to, starting the device, process status, or program execution. In some embodiments the remote can be, without limitation, PDA-like, can serve as a remote for other devices, can be a small computing device, include radio, television, or play and control the optical drive even when the device is turned off. In alternate embodiments the remote may be incorporated into a pen, into stylus 213, or take on any number of shapes and sizes, including without limitation, a keychain. In some embodiments, the device can be closed without turning off the power to device 201.

In the present embodiment, first display 207 and second display 209 are independently controllable by first and second respective processors (not shown) disposed within first panel 203 and second panel 205. The two independent processors are preferably adapted to communicate with one another, to share information and/or to cooperate with one another via a digital interface. In alternate embodiments of the present invention, first display 207 and second display 209 are mostly independently controllable by first and second respective processors, but may have some degree of resource sharing depending upon the needs of the particular application. In some embodiments each display may have a different level of computing power, and in some embodiments each display may have a different functionality. For example, without limitation, one display may be used for scribing while the other display is used for applications and browser software. As noted above, these independent processors typically have separate instances of an operating system running. In the preferred embodiment, the operating systems of the independent processors are the same. Other embodiments may implements alternate configurations of operating systems including, but not limited to, one operating system installed, two instances of an operating system installed, two distinct copies of operating systems installed, two different operating systems installed such as, but not limited to, XP and Linux, more than two operating systems installed as instances, more than two operating systems installed as distinct copies, more than two operating systems installed as hybrids, meaning that some are instances and some may be different operating systems, or one operating system installed operating across two or more displays or two or more computing devices. In many applications, the last configuration listed will most likely result in multiple integrated circuits each powering one computing device and advanced application and operating system software. Any number of computing systems can be configured to operate within one of these devices simultaneously using any number of processors, memory modules, circuit boards, and operating systems. In alternative configurations, the mobile platform for PDA devices can be installed as the operating system on one or more of the displays.

Other embodiments may implement alternate configurations comprising, for example, without limitation, any practical combination and quantity of the following components and attributes configured inside of the device 201: number of hard drives, types of hard drives, number of computing devices, types of computing devices, inclusion of varying technology, number of operating systems installed, types of operating systems installed, number of displays, types of displays, number of circuit boards, number of memory chips, number of processors, types of processors, number of cache modules, number of applications running simultaneously, and types of applications running simultaneously. The device can have one, two, or multiple hard drives installed. The device can run as one computing device, two computing devices, multiple computing devices, or some combination thereof, where the device can easily switch from one to multiple computing devices. Different display types can be configured inside of the device such as same size display configuration, multi-size display configuration, a one-display configuration that can split into two or more displays, or a multi-display configuration. In addition, the device can have any number of circuit boards installed such as a one-circuit board configuration controlling all displays, a two-circuit board configuration behind one or both displays, or a multi-circuit board configuration. Any circuit board configuration can be configured with one or more controller boards. Any number of applications can be running simultaneously as foreground, background, or as scheduled applications. The computing resources can comprise of a single set of processor, cache, and memory for the entire device, or can comprise of multiple sets of processors, cache, and memory operating across one or both displays using any number of configurations. Multiple processors, cache, and memory installed need not be the same size nor the same power. Various operating system configurations can be installed as described. These devices can be configured as laptops, mobile devices, desktops, servers, electronic devices, or as cabinets. Those skilled in the art, in light of the teachings of the present invention, will readily recognize a multiplicity of alternative and suitable configurations with other hardware/software/firmware components, quantities, and combinations depending upon the needs of the particular application.

In some embodments the different display units of device 201 may be connected by multiple simple ethernet-like connections that simulate a network. Also, multiple networking or Ethernet slots may be available for built-in networking technology. Even if no ethernet-like connection exists, the display units should be able to communicate as if they are on a network. In another embodiment this connection between the different display units may be made by USB connections between units. A USB connection allows one display unit to see the other and pass information to the other display unit. Standard cable connections may be used in other embodiments. In yet another embodiment circuitry connects the display units. In this embodiment circuit boards connect or fit into one another and can easily be pulled apart, or a third circuit board connects to both display units and sits between the two display units. In other embodiments a wireless connection may connect the display units, a flash drive-like device may connect the display units, or similar technology to the traditional technology used between a circuit board and a laptop display may connect the display units.

First display 207 and second display 209 may be of any suitable type, but are preferably LCD displays. One or both of first display 207 and second display 209 may also be touch sensitive, thus allowing input by way of stylus 213, through human touch, or by other suitable means. In some embodiments displays 207 and 209 are not touch sensitive. In some embodiments, the displays do not open and close like a book. In some embodiments one or more of the displays may have a door that can be closed any number of ways including by sliding to protect the display(s). These doors may cover one or both of the displays simultaneously. These doors may optionally include a lock controlled by means such as, but not limited to, a key, a remote or a latch to secure the display from unauthorized users. In embodiments that have a door, the door may have buttons on the outer area of the case of device 201 to open and close the device. In some embodiments, doors like this, can be placed on other portions of device 201 such as, but not limited to, keyboards, etc. Regular displays that normally connect to a desktop device can use this door feature as well. In the present embodiment, as shown in FIG. 3, device 201 can function like a laptop PC where display 209 may be used as a virtual or digital keyboard or include digital function keys for entering data in on the other display. In alternate embodiments display 207 can be used as the digital keyboard. Using the digital keyboard, device 201 resembles a traditional laptop because the device is rotated 90 degrees. In some embodiments, displays 207 and 209 can lift to reveal other equipment such as, but not limited to, computing devices, compartments, and/or keyboards/keypads.

The present embodiment is able to run advanced business applications and available business software and able to browse the Internet and perform searches. Also, images may be rendered on any of the displays in any desired orientation such as, but not limited to, portrait or landscape or horizontal or vertical, and suitable software may be provided to allow the user to change these settings at will or to toggle between orientations. Various embodiments of the present invention would allow for the adjustment of components, for example, without limitation, swivel units allowing displays to adjust in any number of directions. In some embodiments any of the displays on the device can be adjusted, and a display can be lifted and pushed back for instance, providing the user with a higher view of the display. Both sides of device 201 can be adjusted. In some embodiments one panel of device 201 can be positioned behind the other panel to hold device 201 in position or to simply carry device 201 in an open position. In some embodiments the two panels can be attached so that a full-display appears without a center media. The panels can also be adjusted wider apart for maximum writing flexibility by pulling the displays away from the other. Either display can stand upright and adjust up and down for viewing flexibility. The device can also stand in an open, upright position on a stand (designed any number of ways), making the open device resemble a desktop monitor with two displays side by side. A keyboard or other desktop peripheral can be connected and used with the device. The device 201, in this configuration, can even attach to a desktop's CPU operating as one or multiple computing devices simultaneously with the desktop CPU. With this embodiment, the stand becomes a docking station for device 201. Many desktop computing device configurations can take advantage of this display design, and when the user is finished for the day, the device on the stand, can be closed and secured. Even with this embodiment, the two displays can still be used as a mobile device by detaching the displays from the stand. Alternatively, one of the displays can be detached, and used as a writing device while still communicating with the second display, and optionally, with the desktop computer. Thus, the multi-display device can be transformed into an alternative desktop computing device that can take advantage of many of the features described in this document. Alternatively, device 201 can sit in a secondary two-panel device in an open position where the secondary device opens and closes much like device 201. When in an open position, both displays of device 201 are revealed on one side of the secondary device. Many embodiments described in this document can sit on the opposite side.

While the embodiment shown in FIGS. 2-4 depicts the device as being equipped with two displays, it will be appreciated that device 201 may have more than two displays. For example, without limitation, in some embodiments, one or both of first panel 203 and second panel 205 may be equipped with back-to-back displays, or with displays that are viewable, in whole or in part, from both sides of the panel. In embodiments where displays are viewable from both sides of the panel, the device may be equipped with software that displays a first portion of the screen so that it is viewable from both sides of the panel or across both panels, and a second portion of the screen so that it is viewable from only one side of the panel. These embodiments are especially useful when the device is being used to display information that contains a confidential portion, which may be displayed in the portion of the screen that is only viewable from one side of the panel, and a non-confidential portion, which may be displayed on the portion of the screen that can be seen from both sides of the panel. Software on device 201 can prevent one side of the unit from being seen by an external network. If there is a multi-network connection (multiple distinct network connections), one or more connections can be disabled immediately by pressing a button located anywhere on the computing device. Some embodiments may include a mini-display along the frame of device 201 that displays user-defined information from applications. This can be information such as, but not limited to, indicators and message notes from applications or email. The mini-display can be any number of sizes and take many forms. This information can optionally be streamed to the mini-display when the device is off.

One or both of the surfaces of each of first panel 203 and second panel 205 may also be equipped with multiple displays. For example, without limitation, a given surface area of a panel may be divided into multiple displays, or a display provided on a surface of a panel may be divided into distinct areas that are independently controlled, by the same or by different processors. In one particular embodiment of a device with multiple displays on a surface of a panel that are independently controlled, each of the processors in the device may control specific portions of multiple displays, and the portion of a display controlled by a specific processor may be the same for each display in the device or may vary from one display to the next. In another specific embodiment of this type of device, each processor exclusively controls one display in the device and also controls a portion of a common display, preferably in cooperation with the other processor(s). In other embodiments, each of the panels may also be equipped with additional displays that are stored inside of the panel and which may slide out of the panel for use. In the present embodiment, panels 203 and 205 may also be equipped with ports for the attachment of additional displays. In another embodiment, one processor can divide its processing resources across all displays in a device through hardware configurations or through software systematically or manually using any number of configurations. Although many embodiments have been described with reference to processors, memory chips and cache settings can be configured similarly across panels, displays, operating systems, and computing devices, without limitation, using single or multiple memory chips, assigned specifically to a single display or multiple displays. Memory and cache configurations can be altered through firmware, software, or hardware. Memory chips and cache can also be attached to a specific processor.

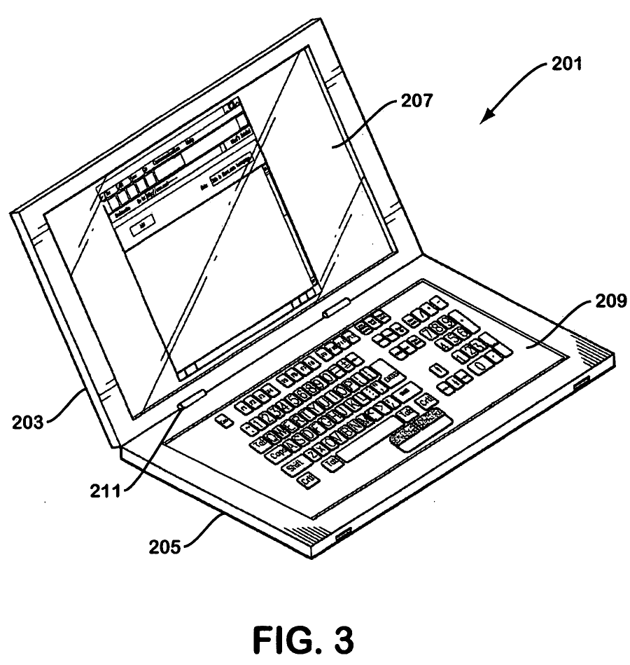

FIG. 5 illustrates exemplary multi-display devices that are implemented in a tri-fold configuration, in accordance with an embodiment of the present invention. While the embodiment shown in FIGS. 2-4 is depicted as having two panels 203 and 205, various devices may be made in accordance with the teachings herein that contain three or more panels, and each of these panels may have any of the features described above. For example, without limitation, tri-fold devices can be made in accordance with the teachings herein, which are equipped with three panels disposed in a foldable arrangement, and each of these panels may be equipped with one or more displays, as shown in FIG. 5. For example, without limitation, a tri-fold device could possibly have three displays or two displays and notepad area. Some embodiments can comprise a display area combined with calculators, virtual keyboards, notepad areas, or scanning regions. Even in another embodiment, a panel can completely flip and reveal one of the keyboard embodiments, configured any number of ways, without limitation. For instance, the panel can be adjusted outward from device 201's center median, partially released from the center median, and then the entire panel (or a part of the panel) can be turned on its opposite side.

While the embodiment shown in FIGS. 2-4 has been described as having two processors which are capable of functioning independently, it will be appreciated that devices may be made in accordance with the teachings herein which have n processors, wherein n≧2. These devices may also be equipped with k displays, wherein k≧2. In some embodiments, each display may be equipped with a dedicated processor such that k=n although k may be less than or greater than n. These devices may also be equipped with b memory chips, where b≧1. The speed of processor (i) is not necessarily the same as the speed of processor (j) given any processor (i) and processor (j) installed anywhere within device 201. The processor speed need not be the same across all operating platforms, processes, panels, applications, displays, within a given display, or across varying electronics and technology installed within device 201. The size of memory chip (m) is not necessarily the same as the size of memory chip (n) given any memory chip (m) and memory chip (n) installed anywhere within device 201. The size of the memory chip need not be the same across all operating platforms, processes, panels, applications, displays, within a given display, or across varying electronics and technology installed within device 201. Various cache settings can be implemented across any device, panel, display, operating system, application, and process.

The size and shape of the displays in the devices described herein may also vary. For example, without limitation, while the displays are preferably rectangular in shape, displays having various other geometries may also be utilized, including, but not limited to, displays that are circular, elliptical, or polygonal in shape. In some embodiments, displays may be odd-sizes, and, when multiple displays are used, these displays do not necessarily need to be the same size or type. In the preferred embodiment, displays 207 and 209 are as wide as possible in the unit frame, and any action button on the frame should be as small as possible for functional use. The buttons can optionally retract/expand as needed, for example, without limitation, the buttons can pop out of the display frame when ready for general use and retract back into the case of the frame when not in use. In some embodiments the displays have a clear coating similar to glass or a touch-screen type of material. The displays are preferably framed with a plastic material or metallic material, buttons appear slightly raised on outer areas of displays, and the displays are standard color displays. The displays may have rounded edges and may use a soft material. One of the panels may comprise of some combination of television, stereo, radio system, optical disc drive technology, advanced audio equipment, or media technology disposed within a display.

While the devices described herein are preferably small, handheld devices, it will be appreciated that the principles described herein can be extended to various other devices, including, but not limited to, laptop and desktop computers or even as large as a television monitor or bulletin board or white board. Also, various embodiments of multi-display devices may be different sizes. The preferred size for the multi-display device is slightly smaller than a traditional notepad and resembles a traditional planner. However, the multi-display device can be almost any size for example, without limitation, a notepad sized or legal sized device, a pocketbook sized device for travel that could hold an airline-sized ticket, a traditional PDA-sized device, or a small business card sized device. Also, multi-display devices can be connected to each other. When a larger multi-display device, such as, but not limited to, a notepad sized device, is connected to a smaller device, such as, but not limited to, a PDA or pocketbook sized device, the display areas are adjusted, and the view can be in single or dual mode. When displays are detached, the devices can communicate as if they're siblings on a network. Device 201 can operate as if it is multiple stand-alone devices on a network whether attached or detached, running applcations in its own environment. Device 201 can divide its task across panels, displays, operating systems, and computing resources.

Some embodiments may have one or more additional mobile devices that can be detached from the full unit. One display unit from the multi-display device may be able to control the second display unit even in a detached mode. The additional mobile devices that can be detached, can optionally fold close like a book, similarly to device 201. This embodiment can be any number of sizes and use any of the features described herein. In some embodiments, panels 203 and 205 may optionally be detached from one another and optionally used as independent or dependent mobile devices. These embodiments require specific configurations, for example, without limitation, a button, latch, or other operator on the device that releases and detaches panels 203 and 205. These pull-apart embodiments are controlled by the main circuit board or a secondary controller card. Detached units are able to communicate with one another simulating a mini-network using any number of methods such as but not limited to wireless technology. When detached, the operating system on each unit can operate on its own. This is done for example, without limitation, by making a copy of the operating system available to each unit, by running an instance of an operating system on each unit, or by running an operating system on the secondary unit that is similar to Linux or the operating system for a dummy terminal. When detached, the detached device can run an operating system temporarily such as a mobile platform. When detached, the secondary unit can serve a totally different purpose such as, but not limited to, a scanner, a projector, or a presentation vehicle for the first unit for example, without limitation, the secondary unit can be placed on a tabletop to display slides from the primary unit. The secondary unit can also operate as an external device such as, but not limited to, a hard drive, an optical disc drive, etc. Advanced DVD/CD functionality may be provided on one or more units that operate in conjunction with one or more displays with all types of writing technology. Also, one unit can optionally have the wireless infrastructure inside the unit to allow wireless communications.

The optical disc drives can be operated from buttons on device 201, installed software, or buttons on the optical disc drive. If applicable, the optical disc drive can have a display on the exterior of the drive to display information such as, but not limited to, titles, status of a process, or any number of other applications. An optical mini-display can be located on the frame of the computing device providing similar functionality. A pull and go mobile optical disc drive can be installed where the optical disc drive can be ejected from the housing of device 201, and used as a mobile device. In some embodiments the optical disc drive can play music without powering the resources of device 201. When in this mode, the batteries of device 201 are being used. Also, when not powered up, a small mini display can display disc contents and other information related to the disk being played. This small mini-display can be located on the exterior of device 201 and can work with the optical disc drive when device 201 is not powered up. Advanced software techniques will be used to manage the disc drive and the disc contents. In some embodiments advanced multi-display devices can be designed to be used with a number of optical disc drives located across both display units. The optical disc drive installed on device 201 can use slot openings instead of the traditional tray optical disc drive. A hinged door can cover the opening of the disc drive. The optical disc drive can be secured separately from the computing device. Even when the computing device is in use, the drive can be locked, for example, without limitation, with a key, a button, or a remote.

Since the device 201 has multiple displays 207 and 209, preferably two, special design considerations must be given to the notion of pulling the displays apart and allowing multiple users to interact. Preferably, the user should be able to interact with either side randomly even when running multiple versions of the same product. The user is able to easily switch between displays 207 and 209 and applications at the touch of a button. A mouse, stylus 213, or a pen is also available for use on either side. An alternate embodiment of the present invention has a one to many method for displays where displays can be connected or disconnected, operating off of many circuit boards which can be detached from one another. This embodiment preferably includes one large display with one or more mini-displays that can be attached or detached from the main display.

The exterior and interior of the devices described herein may also vary in shape, for example, without limitation; they may be rectangular, square, round, have rounded edges, etc. Some embodiments of the multi-display devices will have a section for a traditional notepad positioned on the device, for example, without limitation, on the left-hand side behind one of the displays, or conveniently located at the bottom of the display. One embodiment includes, without limitation, a half-display on the top right side and a paper notepad at the bottom right side. Credit card holders, business card holders, and/or paper document holders can be substituted instead of an area designated for a notepad, without limitation on the design, the notepad area can be used jointly or interchangeably as a notepad area and an area for business cards and such. Another embodiment includes, without limitation, a full display on the right, and some combination on the left of the following, holders for credit cards, holders for notepads, calculators, and areas for other paper documents. Technology for this embodiment of device 201 extends across both panels including behind the area for the notepads and such. This enables the device 201 to still contain twice as much technology than a typical computing device. This embodiment can be extended to laptop and other similar electronic devices whereby the technology extends across boths sides of the device, the display and the keyboard, potentially providing twice as much technology (ie. storage area, processors, memory, etc.) to the device 201. This embodiment can generally be applied to any computing device, without limitation, extending technology across any and all internal components and connecting peripherals including displays, keyboards, external devices, CPUs, and pointing devices. Technology is maximized in the structural housing using many potential configurations while reducing the number of physical components. For instance, a desktop computing platform can include a display, a keyboard, and a mouse, with computing technology extended across all three components, providing more than the typical computing resource found within a typical corporate desktop. Thus, in general, a computing platform can consist of components {c(1), c(2), . . . , c(i), . . . , c(n)} where any c(i) includes computing resources, without limitation, a storage area, processor, memory, and etc. In addition, any c(i) and any c(j) can communicate as if they are directly connected, any storage area for any c(i) and any c(j) can be shared storage areas for the entire computing platform, any memory for any c(i) and any c(j) and any processor for any c(i) and any c(j) can be used across the entire computing platform. Given any c(i), the processing environment can operate independently from any c(j), codependently with any c(j), or as a dependent node of the computing platform. These devices can be folded any number of ways. One or more displays of the mobile device can stand tall on the desktop. The multi-display device can stand vertically using a rack or a stand. Also, the multi-display device can use a stand to slant the device at an angle if desired. In some embodiments a rack can be found on the back of the device. Racks and stands can be designed any number of ways, take on any number of shapes and sizes, are detachable embodiments, and be made of any number of materials, such as, but not limited to, metal or plastic. In some embodiments the multi-display device can plug into a docking station. The docking station may connect to a network, larger monitor, printer, scanner, or any other peripheral.

Action buttons on the exterior of the multi-display devices can be designed any number of ways and located any number of places. Any program can be executed and associated with an action button. In some embodiments digital buttons can be used, which are buttons that display digital text and can be changed, for instance, without limitation, the user can change which icon appears on the digital buttons. The user can toggle between the different displays on the device to execute various commands any number of ways including, but not limited to, pressing buttons on the frame of the device.

Some embodiments of the present invention may include a handle to carry device 201. Handles may be of any shape or size and may be located anywhere on device 201 or may be located on a separate carrying case. Some embodiments may include a carrying case without a handle. Carrying cases can be made of many materials such as, but not limited to, leather, plastic, nylon, rubber, metal, marble-like material, granite-like material, wood-like material, or a flexible material, may be any color, and may be engraved for example, without limitation, with a corporate name or the user's initials. Carrying cases may be designed any number of ways. For example, without limitation, device 201 may be wrapped in a leather binder or positioned inside a carrying case like a traditional planner including space for paper and items such as, but not limited to pens, pencils and business cards. In some embodiments device 201 can be secured in a carrying case by way of means such as, but not limited to, a latch, a pocket, or Velcro. Some carrying cases may be opened and closed by means such as, but not limited to, a zipper, snaps, or Velcro. In some embodiments a pad of paper and/or pockets for business cards, calendars, and project lists, etc. may be included in the carrying case. Since in many of the embodiments, device 201 has a durable outer case, a separate carrying case may not be necessary. Also, the carrying case may include a lock on the outside to secure device 201 within, controllable by the same key or remote as used with the device 201, although a different key or remote can be used.

Some embodiments may include an optional remote control. The remote control could be built-into the frame of device 201 or can be a stand-alone peripheral device. The remote control may come with or without a display. If the remote control is built into the frame of device 201, then it may take advantage of pull-off technology; it can become detached from the unit for example, without limitation, by pressing a button. The remote control allows the user to perform functions such as, but not limited to, controlling the computing device, viewing files on the display of the remote, checking on the status of processes, or retrieving email or instant messages. In some embodiments a pen device or stylus 213 can serve as the remote. The remote may also be used with other electronic devices including, but not limited to, laptops, desktops, servers, PDA, televisions, stereos, and appliances. The display remote can comprise a microprocessor, memory, stylus or pen device, audio features, PDA-like features, other circuitry, and can allow the user to use various installed applications.

In some embodiments the frame of the device can optionally have a microphone shaped any number of ways. For instance, without limitation, a full-size microphone can be released from a compartment or lifted from the side of a device. These microphones can be adjusted (height and position). Small microphones can be located any number of places on any of the computing devices described herein. A microphone clip can be released from the device, for example, without limitation, from a compartment or pulled/extended from an area of the device. The microphone clip can be extended from the side, and optionally fully detached. Some embodiments may have speakers that can be pulled out or extended from the device that adjust and swivel. These embodiments may also have audio features including, but not limited to, volume control. A microphone and speakers are features of embodiments that are audio notes enabled, where the user is able to record an audio note to include with any document, any email, any note, any file, etc. An audio note is a voice recording that can have text, images, notes, etc. attached to it any number of ways. These items are grouped together, and can be passed on to others via common file delivery methods. These embodiments may also have an audio note database that stores audio notes and other needed information. Indicators may be used to notify the user that text and/or audio notes are available. An audio button for recording, speaking, and sound may be placed in any number of locations on the device, and more than one audio button can be located on the device, for example, without limitation, one audio button per display. The device may have a mini-display to display seconds and minutes transpired during a recording session. Software enables quick recording of audio notes by pressing the audio button, and then the note can be acted upon, for example, without limitation, sent through email immediately, attached to a document or file, stored in a database, or sent through instant messaging. Pull-off technology is also available for these audio features, for example, without limitation, a pull-off digital recorder or a pull-off mp3 player.

There are many options for media storage in the various embodiments of the present invention. In the preferred embodiment, the minimum disk space is 30 G per panel. The dual-display environment can operate as one computing device and treat hard discs as shared drives, or in other embodiments the user can purchase space for one panel only and segment across both panels. A removable smart media card and/or two or more media slots may also be available in some embodiments. Multiple USB drives for flash drives, media cards, DVD/CD drives, and other devices without limitations. Dual-layered enabled DVD/CD drive is preferred. Some embodiments may have an optical disk drive installed in one or both display units. Pull-off devices such as, but not limited to, mp3 players, cameras, and audio/video recorders will also be able to store data. Embedded hard disk space, microprocessors, and a removable memory storage area may be available in some embodiments.

The preferred embodiment uses internal flat batteries so that more batteries can fit into the device. The device can have one or more batteries installed, thereby extending the number of hours the device can be used without power. An all-day battery can be installed that allows the device 201 to be used eight hours or more without a power cable. If multiple batteries are installed, they are installed and configured any number of ways without limitation on the design. Battery power status appears on one of the displays or on a mini-display. A toggle button can be pushed to toggle to the number of minutes remaining on each battery installed. Some embodiments may have battery eject buttons to release battery from housing of device 201; the same type of eject button can be used for other parts of device 201 such as, but not limited to, the hard drive or optical disc drive. A USB cable may be used to charge the internal batteries from an external source, and in some embodiments internal batteries can be used to charge other internal batteries. Some embodiments may allow the user to put the device in a writing-only mode for reduced power consumption, or a battery saver mode where a temporary battery supply is used until the main battery supply is replaced. Some embodiments may be solar or fuel cell powered devices. Conventional power cables are also available. In some embodiments a power cable may pull out of a compartment in device 201 using a spring-like cable. Each panel can have its own power cable, although, when the panels are connected and operate together, only one power cable is needed.

The devices described herein may also be provided with the various accessories and software found in other PDAs, laptops, and desktop computers. For example, without limitation, these devices may be equipped with one or more removable flash drives. In some embodiments, these devices may also be equipped with one or more still or video cameras. These cameras may be set in a fixed orientation, or may be adjustable to point in any desired direction or range of directions. For example, without limitation, in one embodiment, the device may be provided with a plurality of cameras directed in different directions. In some such embodiments, the view through each of the cameras may be rendered on a separate display within the device. Built-in cameras may have a single or dual-lens. Also in some embodiments, the camera can be detached from the device. Camera technology and lens can be installed in each panel of device 201.

Some embodiments may have a pull-out camera; a thin device that can be pulled out of a compartment and adjusted for viewing, or completely pulled off of device 201. The camera can record and watch films on any of the display units. The camera can be located any number of places on the frame of device 201. The camera also can be retracted back into the frame and released from the frame when needed. The camera can take on a design that includes two cameras back to back so that the view in front of the user can be seen as well as the view towards the user, or the camera can swivel either direction by pressing a button or the camera itself. A PCMCIA-like card or a flash-like device can contain camera technology and can be used with a multi-display device or any other electronic device. The lens used with the PCMCIA-like card can be a secondary component from the card, or can be detachable from the card. Device 201 may also have video recording capabilities. Video appears on one of the units as recording occurs, and the built-in video camera can have the capability of recording two or more distinct sessions simultaneously even if device 201 has only one built-in camera. In this case, the camera has multiple lenses and imagers built into the housing of device 201. A number of designs are available for this feature. Both displays 207 and 209 can be used as a host for a live video simultaneously, video conferencing, web casts, or television viewing.

An advanced microphone can be designed to work with the multi-display unit. The microphone device comprises a storage area, memory, processors, and small displays, and data can be stored on this microphone. The microphone can be completely integrated into device 201 or optionally detached from device 201. The microphone also can be pulled from a compartment, retracted and expanded when needed, pulled from the side of device 201, or the microphone can be pulled out and adjusted to stand as a normal microphone would stand. The microphone has its own controls such as, but not limited to, mute buttons, action buttons, and on/off buttons.

The multi-display configuration for computing devices according to the embodiments described herein allows the combination of many different technologies because of the added space for additional circuitry provided by the second display. This additional space makes it possible to group advanced technology with common devices. Thus, some embodiments of the present invention may have many advanced applications and solutions installed on device 201 including, without limitation, incorporating technology such as, but not limited to, scanning, printing, and many camera technologies. In embodiments that include a built-in scanner, the scanner may be any size including, but not limited to, business card size using any number of scanning methods and designs. If scanning technology is added to one side, scanned information can be viewed on a display as the document is slid into the scanning device; many different types and sizes of scanners can be designed. The additional space also makes it possible to add more memory or extra disc space because memory modules, processors and other circuitry can be situated across multiple boards, or, in some embodiments, multiple batteries may be included to extend the battery life, for example, without limitation, one battery for each display. The dual display configuration also allows for increased processor power by operating across one or multiple circuit boards, or a simulated multi-circuit board. A simulated multi-circuit board has circuitry for more than one panel or more than one computing device, for example, without limitation, one board runs two or more computing devices, or one board controls both displays and panels. The dual-display technology allows for advanced backup solutions because twice as much hard disc space can reside on device 201. Backups can occur during peak hours, silent backup processes can be initiated on one of the extra hard drives using a partially or completely dedicated processor, and more backup data can be stored on the device 201 itself. Silent processes include processes that execute, using dedicated computing resources, while other applications are running. Some embodiments may combine traditional laptop and desktop functionality with PDA functionality. For example, without limitation, a PDA device can be integrated with a mobile planner, a desktop, or a laptop, or can be a pull-off/pull-out device where the PDA can be detached from the unit.

Some embodiments may also include audio features such as, but not limited to, a radio tuner, an mp3 player or a CD/DVD player. In some embodiments the CD/DVD player can be a dual layered CD/DVD player that has the ability to read both sides of the CD or DVD. Imaging technology may be installed, various camera technologies such as, but not limited to, digital cameras and video camcorders with or without zoom features may be utilized, and smaller printing technologies may be added. In some embodiments, telescope and binocular technology may be installed, and the ability to take and edit photos may also be included. In some embodiments television tuners can be installed to be viewed on displays 207 and 209. In some embodiments, medical and biotech technology may be installed on one or more sides of device 201. For instance, without limitation, microscope and pull-off stethoscope technology can be partially or fully integrated within device 201. Advanced technology in science and environmental areas can be integrated as well. With all of these technologies, embodiments and internal components may be designed any number of ways. Some embodiments may include pull-off components; pull-off components can be detached from the computing unit and used as a mobile device. These devices are typically peripheral devices including, but not limited to, cameras, mp3 players, PDAs, etc.

Moreover, while the displays in devices made in accordance with the teachings herein are preferably independently controllable, it will be appreciated that, in some embodiments, the displays may be configurable, as, for example, without limitation, by changing a software setting, into a state where all of the displays show the same image, or display separate portions of the same image. In embodiments where the displays show separate portions of the same image, the rendering of images may be coordinated among the displays so that the displays act as units of a single, larger display. In embodiments where the display may be expanded across multiple displays, the user may be able to quickly expand the display area by means such as, but not limited to, pushing a button, using a remote, or by a software selection. Applications can be dual-display ready where the application is preprogrammed to display certain portions of the application on either display. Any application can be adjusted over the two display areas keeping sections fixed on either side. The user can also preprogram where an application should appear. Most likely, the applications will use its last setting. In some embodiments the device may also be able to split-screen an application on one display or on multiple displays. In some embodiments the different displays may have different properties such as, but not limited to, resolutions, fonts, background color, etc. The user is able to switch applications from one display to the other, and there is no restrictions on which display an application can use or what can run on either display. Also, the user can break one panel into multiple windows while using the full display on the other panel. In some embodiments the user can transfer an application from one panel to the other by selecting an action button on the display frame.

Many embodiments of the present invention can run two or more instances of any software that is resident on the computing device or on the network if the device is connected to a network. These embodiments can also run two or more different copies of the same software application or two or more different applications on device 201. An application can be started on either display through means such as, but not limited to, menu picks, buttons along the frame of device 201, or via software. Configurations can preload applications according to a schedule. The multi-application environment consists of multiple applications running on any display simultaneously. It also consists of both displays, simultaneously, running one or more applications simultaneously. The applications can communicate, share data and information, and execute actions in the other software. The same application may be able to execute different parts of the same application on two or more sides of device 201 simultaneously. The same application may be able to run on two or more sides of device 201 simultaneously, each operating independently. This is particularly useful for functions such as, but not limited to, providing benchmark and performance metrics for software or business processes. The applications can run independent copies of the same software or different instances of the same software. The two copies can operate independently or dependently where one side talks to the other side.

Similarly for the operating system, many embodiments of the invention can run multiple instances, multiple copies, or different types of operating systems, such as, but not limited to, Apple and XP, XP and Linux, or XP, Linux, and Apple, etc. In some embodiments each side of the device can run multiple operating systems. Also, in some embodiments, the device can have one or more start menus so that the operating system can resemble one or more operating systems.

Various embodiments of the present invention include dual-sided software operating independently or together across both displays where one feeds the other information as a master/slave operation. This is an application technique where two applications communicate with one another exchanging data and information, for example, without limitation, a CRM package plus email, or a CRM package plus email plus project planning. Synchronization occurs seamlessly between the various packages. In some embodiments software can be installed that tracks the security of the device.

The circuit boards of the devices described herein may be designed in many different ways. In the preferred embodiments the circuit board comprises memory, processor(s), media slots, a camera, DVD/CD, a hard drive, USB and connectors for all peripherals, power on/off, control for action buttons, a graphics card for display and imaging, possible scanning capability, and an operating system to handle software and scanning capability. Some embodiments may have embedded hard disk space on one or both circuit boards. The embedded hard disk space on the circuit board offers similar functionality as a mobile device such as a PDA. In some embodiments the device may include a WIFI sensor and/or technology integrated on the circuit board for complete wireless capabilities. Also, the device may optionally include one or more antennas for wireless applications such as, but not limited to, the Internet, cellular applications, television, and radio. The device can toggle between the various sources of data if there is only one antenna, or the antenna can be equipped to receive multiple signals and decipher between them if advanced antenna circuitry is available. The antenna can be designed and configured any number of ways, without limitation, built-into device 201, detachable from device, can fold down when not in use, retract back into a holding area, can be any number of sizes, one positioned on each panel, and comprise advanced technology including microprocessor, storage area, and audio capabilities. An inner cooler or fan can be turned on and off automatically or systematically when the circutry becomes hot. This is particularly important for multi-display, multi-processor computing devices. The cooling method can be designed any number of ways including, without limitation, as an integrated chip, built-in any number of components on or connected to the circuit board, or an advanced method can be designed where a cooling system or fan sits entirely below the circuit board and can cool any component and circuitry residing in the device 201. Any number of cooling systems or fans can be installed inside of the computing device including at least one behind each display. Multiple USB ports may be available on circuit board, and these USB ports can be smaller than the standard USB ports. An adapter will be needed to convert the ports back to normal size.

Some examples of possible circuit board design include, without limitation, the use of a separate circuit board for each display unit with a controller board to manage the communication between the circuit boards or the use of one circuit board to control and manage all of the displays. Some embodiments comprise a circuit board made up of many circuit boards connected or built-into one board, or multiple boards for one or more systems, which means that the multiple circuit boards provide computing resources to one or more computing devices.

The architecture of these boards may also vary. In some embodiments the circuit boards may be stacked, stacked back to back, and in some embodiments the circuit boards may be of varying sizes and dimensions. A back-to-back circuit board is layered with circuitry on the front and the back of the board. This type of board can be used to add extra power, battery supply, two or more processors, enhanced functionality, extra memory, etc. One of the display units can use memory and resources from the other unit designed and configured any number of ways. Many advanced technologies can be used to design circuit boards for the multi-display device and other computing devices such as dual-loaded technology configurations, dual-circuit boards, or any other advanced technology method. Dual-layered or dual-loaded circuitry designs provide double the amount of resources for any item on the circuit board. For instance, without limitation, memory, processors, communications, bandwidth, and even the manner in which the circuitry communicates on the board can be increased because there are more ways to send signals across the board. Dual-layered technology can take on a number of designs and configurations. One design literally stacks technology, circuit to circuit, with a thin layer between, sharing some technology components, and possibly reducing the amount of technology needed on the board. More than two circuit boards may be assembled together to make up one circuit board using this technology method. Some embodiments may have circuitry integrated into the back of the case of the device. In other embodiments the circuit layer may be a separate component on the board so that the entire inner unit can be pulled out for repair. Dual circuit boards may also be included inside of other computing devices such as, but not limited to, desktops, laptops, tablets, PDAs, pocketbooks, servers, and other electronic devices. The dual boards may use the back-to-back configurations, or they may be configured as two separate boards. Each circuit board can represent a separate computing device. Some embodiments may include a modular circuit board or pull apart circuit board that gives the user the ability to pull out components such as, but not limited to, processors and memory cards easily for upgrade purposes; this applies to mini-circuit boards as well. Wireless and network architecture may include, without limitation, a single or multiple connection structure. Some embodiments will require multiple connections to a corporate network or the Internet including, without limitation, configurations for demonstrations, client/server system setup, and configurations for developers and administrators.

Depending on the type of system being designed, communication between displays, computing units and input/output devices may be accomplished through different means. In some embodiments a controller board, as described in the previous paragraph, can control all of the communication. In other embodiments the communication can be controlled by wireless means or by traditional wired means, and in yet other embodiments, the units can communicate through means such as, but not limited to, flash technology, USB, or cables.

Many embodiments use “thin-layered” technology specifications. In the present discussion, “thin layered” technology specifications refer to layering the underlying technology of the device, such as, but not limited to, circuitry and peripherals placement, so that the device, when opened or closed, remains thin, light-weight, and easy to carry anywhere. “Thin layered” technology specifications may be applied to any device designed, according to embodiments of the present invention, from the small PDA versions to the larger versions.

Some embodiments may include software applications that are enabled for displaying and taking advantage of the multiple display technology. For instance, an application can split itself across multiple displays, for example, without limitation, one module can be displayed on one side of the device and another module can be displayed on the other side of the device. Some embodiments may also include an application-aware multi-display software technique that recognizes whether a device is operating in multi-display mode and whether or not multiple operating systems are running. In some implementations a note-taking application may be added that is displayed at the bottom or along the side of one of the displays for note taking and analysis. This note-taking software can be integrated within, without limitation, any open application, the operating system, an application provided with the multi-display device, or a third-party note-taking software application with advanced note-taking features.

Any of the embodiments described herein may be note-ready, meaning that the user can take notes while using any application, and can easily write a quick note anywhere on the device. In some embodiments these notes are added to a database for shared collaboration and further analysis. Notes may be digitized, categorized, and organized instead of simply typed over into a processor or a database. In some embodiments, data and notes may be synchronized, shared, and available for collaboration with a notes database. Notes may be added to the database, for example, without limitation, by attaching notes to a subject in the database, or by associating the notes with a document. Two types of data can be merged into the same document, for example, without limitation, word plus notes or spreadsheet plus notes. In some embodiments, every note written anywhere on the device, including, but not limited to, inside documents, can be organized and associated with another object. Some embodiments may include the ability to digitally record notes on an application such as, but not limited to, a calendar; these notes can include audio and digitized text. Some embodiments may include a record “anywhere” or “everywhere” application by using a button located, for example, without limitation, on the device, stylus, a pen device, or a remote. In this embodiment, recording is captured immediately and stored and linked to a file, object, or data. Audio recordings are stored in a database, email client, or other audio organizer. Notes are quickly organized and categorized anywhere when the user performs an action such as, but not limited to using a button or by right clicking and adding the note to a database.

Various embodiments are able to use writing and drawing, capabilities with any application for example, without limitation, the user is able to write on the display over an application even if not pen-enabled and capture snap shots with pen writing. Drawn text can be converted (graphics) to objects out of a database such as a box, circles, or lines immediately or as requested by the user. The user is able to quickly add a signature to any document by right clicking, pressing a button on the stylus, or by pressing an action button on the frame of the device. In many embodiments the user is able to write anywhere in any application using a stylus. An aspect of a stylus included with some embodiments that are writing enabled is the ability to quickly change from a pen mark to a marker-like mark while writing. Some embodiments may include an application for handwriting recognition and/or an application for the conversion of handwriting to text. In some embodiments data written on the displays can be automatically or systematically be added to a form so that it appears organized. The data written on the display can be converted to an application such as, but not limited to a spreadsheet, to a word processing document, to a database, to a table, to a graph, to an image, to an agenda, to a project task, to an email message, or to a phone call, for example, without limitation, the user can write a number and have the device dial the number. In some embodiments the user can write a symbol, letter, or other character, then press a button or take some action to open or launch a program. A comfortable writing area is provided in some embodiments that are writing enabled. When a user scribes on the writing display, the hand and arm are at rest on a portion of the device. These embodiments use a material for the frame of the device that is softer and that retracts and expand according to the weight of the arm.

Some embodiments may also be research-ready, meaning that the embodiment includes software that allows information such as, but not limited to, data, notes, images, search results, or web pages to be placed into a secondary document such as, but not limited to, pdf, word, etc. for organization and research. The secondary document stays open and can be subject oriented. The information may also be stored in a database, and the information can be automatically annotated with the proper references. In this embodiment, as information is added to the secondary document, the information can be systematically organized. The user is able to select text from any type of document or page, and perform an action, for example, without limitation, right-clicking, to add the information to the secondary document.

Various embodiments of the present invention may implement what is herein referred to as an “many to one” method of the present invention, which is to mean that there are n units housed within one device. In embodiments implementing the “many to one” method, two or more complete computing systems may be in the same housing connected via means such as, but not limited to, a corporate network, a controller card, or any other connection method. Also the multiple computing systems within the same housing, can communicate with each other. These computing systems may be independent, codependent or dependent of one another. Computing systems available include, but are not limited to, XP™, Apple™, Linux™, Solaris™, and even mobile environments. The device is able to run as many copies of the same or different operating system as possible on any of the devices. In embodiments where the display is on the exterior of the device, the display may perform functions such as, but not limited to, toggling between devices, checking status, browsing through files, or executing any number of applications.

Embodiments of the present invention using “many to one” technology may require a multi-network connection configuration. These embodiments allow high performance servers to run two independent backup processes against the primary server using the advanced notions described herein. Servers using “many to one” technology can be practical for uses such as, but not limited to, file servers, mail servers, backup servers, development and test servers in one box, administrator devices, IT systems, testing servers, demonstration servers, gaming devices, varying technology devices (computing and medical), varying platform devices (XP and Linux, XP and mobile), and other back office applications.

In “many to one” embodiments, the multiple computing devices in the singular housing may be designed any number of ways, for example, without limitation, vertical, horizontal, or using unusual placement, for example, without limitation, in the display or keyboard, or as an adapter. These types of devices can use a single or a multiple display configuration. Some embodiments of “many to one” computing devices have software that can quickly attach or detach a peripheral to any computing device in the computer. This includes, but is not limited to, network cards, optical disc drives, etc. Some embodiments also include software that allows users to see a visual representation of a peripheral device such as, but not limited to, an optical disc drive, a camera, a network card, etc. Also, software or hardware allows the display to show both computing devices or show only one. Some embodiments include buttons that allow the user to switch between displays and computing devices. These buttons may be located anywhere on the device.

Embodiments of the present invention implementing the “many to one” method may use multiple mini-circuit boards assembled together for their circuit configuration. This configuration allows the circuit boards to be easily pulled apart. The circuit boards can represent many different computers, or 1 computer with circuit modules that can be easily pulled apart. The extra circuit boards can serve as a backup system for the main computer. For instance, without limitation, a backup supply of memory, processors, and other circuitry that can be switched out easily using any number of methods via hardware or software if a processor or memory chip fail can be made available. The mini-circuit board system can optionally have all disjointed, disconnected or connected devices mimicking a puzzle of many pieces, all communicating and sharing data, some dependent, some independent. Some of the components can be repositioned on the circuit board. Using the mini-circuit board system, a process can be off-loaded to one of the circuit modules during intense computations.

Off-loading can also be used in other embodiments to off-load a process or an application to another system temporarily. Off-loading pushes a process or part of a process to an independent-like set of chips or to another device. In case of a multi-display unit, according to the embodiments described herein, a process may be off-loaded to a secondary display or unit, or a set of chips on the current device may be used. This chipset appears to operate independently. In order to off-load applications and processes, an operating system, memory, processor, and hard disk space is needed. If off-loading to the same device, the chipset can run another operating system such as, but not limited to, Linux. The purpose of off-loading is to use an independent set of computing resources, for example, without limitation, operating system, memory, processor, and possibly hard disk space.

In alternate embodiments the “many to one” method may be applied to other devices such as, but not limited to, cameras, printers, copiers, cellular phones, PDA, laptops, servers, desktops, boards, chips, memory, processors, ports, storage medias, controller cards, circuitry, electrical signals that move through a circuit board, bus, etc. For instance, without limitation, a camera that is installed on a laptop can be comprised of two cameras instead of just one, or a printer can embody two printers in one housing allowing the printer to issue print commands as if they are separate devices printing documents into separate trays. The “many to one” method may also be implemented in the arrangement and placement of technologies in the same housing or in different housings. Another example, without limitation, of the “many to one” method being applied to cameras is to combine a digital camera with a camcorder. The imaging and display area of the camcorder that is normally used to view photos can be a detachable digital camera with a display. This example also assumes that the digital camera and/or the camcorder technology has the circuitry necessary to store, process, manipulate, and display photos such as, but not limited to, processor, memory, and hard disk space. In some embodiments, the “many to one” method may also be applied to Ethernet cards or, modem cards designed any number of ways such as, but not limited to, integrated circuits, external devices, and PCMCIA card sizes.

There are other uses for multi-display digital computing devices such as, but not limited to, as an enabler for cellular phone and pager use, as a recording device, both business and personal use, and as a medium for television. In some embodiments television, radio, voice sound and audio technology may be optionally included with the device. In some embodiments one or more displays may be added to any computing device, electronic, or even to any and all cellular technology with or without detachable/pull-off capability. Various embodiments of the present invention may use applications that are certified to take advantage of the multi-display environment. For example, without limitation, the dual-display or multi-display mode offers many advanced solutions such as, but not limited to, note areas and module splitting, which automatically splits software modules on certain displays, etc. In embodiments that include a note area, the user can take notes on the note area/first display while viewing an agenda on the second display, or vice versa.

In some embodiments, sticky notes technology can be used with a multiple display device. Sticky notes technology includes, without limitation, small displays that can be written on with a digital pen, or the ability to add a note anywhere on the digital organizer and eventually organize the information in the proper database or application such as, but not limited to, a calendar, task lists, project planning, reminders, etc. Some embodiments would also include a method to quickly organize a sticky note by simply adding it somewhere such as, but not limited to a “file cabinet”, a database, a table, or otherwise. The sticky note can optionally have menu options available for quick categorization and a selection button labeled such as, but not limited to, “file” or “categorize”. For instance, without limitation, a user can select a sticky note, write a contact's name and number, and categorize it as a contact. The sticky note is marked for filing, and, if additional information is needed, the information is prompted for at some point before completion similar to a reminder or alert. Digital sticky notes come in a variety of sizes for example, without limitation, a single note or a database full of notes, and can easily be transferred to another person by digital means or physically. Some embodiments also include a method to initiate a sticky note by a button on a stylus, which provides quick access to a note no matter what state the device is in at the time of initiation.

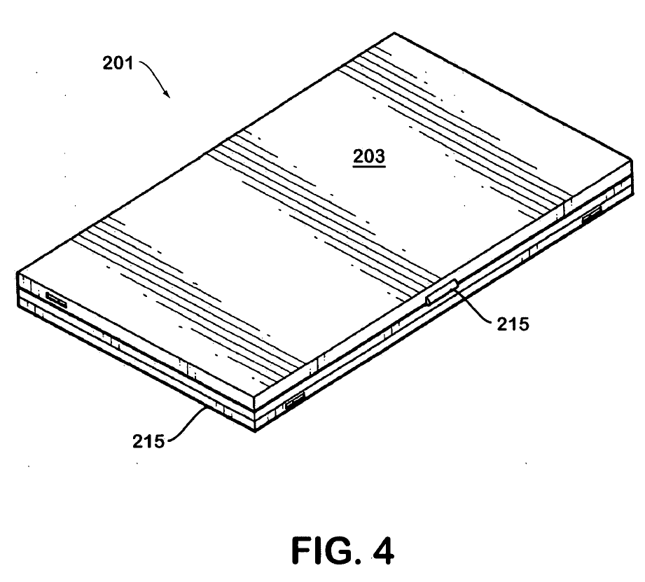

FIG. 6 illustrates exemplary mobile multi-display devices that are designed for writing, viewing data, and using a cellular phone, in accordance with embodiments of the present invention. The devices can be folded, closed, and secured. An aspect of this embodiment is that the user is able to take notes while talking on the phone with associates, prospects, or customers. A phone area 601 can be a digital cellular phone or a regular cellular phone that preferably detaches from a writing/display area 605 of the device. Writing/display area 605 may be used to retrieve information from the Internet or a corporate database. If the device is note enabled, notes from writing/display area 605 can be organized, categorized, saved, and stored. In addition, data can be retrieved onto the writing/display area 605. The user can then mark up the data with information from the associate, prospect, or customer. A device 610 is an example of a device with a separate writing area 615 and a display area 620. A smaller version of the embodiment can be designed, for instance, without limitation, by combining the notion of the cellular phone with a writing display, and completely integrating the two systems, or by making a foldable edition of this embodiment. An alternative embodiment includes, without limitation, a writing display on both inner regions and a phone that sits on the exterior of the device and is used when the device is folded. The phone unit can swivel around on the upper region so that the user can manipulate the phone while writing notes.

In an alternate embodiment, the device can be converted from a dual display device to a device with one full display. In this embodiment a divider between the two units can be opened to reveal a small display which connects to both sides. The divider between the two units can be adjusted so that the two displays can be connected or joined. Many derivations of this embodiment exist including, but not limited to, having a mini display that can be pulled out from one of the display units.

In an alternate embodiment, a set of disconnected displays can be connected to a multi-display unit wirelessly or by wireline. Software can allow the disconnected displays to be managed and controlled by the multi-display device or any other computing device. The disconnected units and primary multi-display device can operate as one unit, updating applications across all devices simultaneously. Resources can be made readily available to any unit that needs the extra computing power, for example, without limitation, a group of individuals working together on a project can use this closely integrated computing system to share resources.

An alternate embodiment of the dual display device is a device that looks like a traditional tablet design but can be folded in half, transforming it into two displays. This embodiment can then be rotated 90 degrees and used in a similar manner to a laptop PC with or without an attached keyboard.

Another alternate embodiment of the present invention is a one-sided version of a multi-display device that resembles a traditional tablet. This embodiment can be much smaller than the traditional tablet. The preferred size varies from a traditional planner size to the size of a PDA but can be even larger or smaller. It is much more flexible than a traditional tablet and may have a case enclosure or a binder. It can be carried with much more ease than the tablets found on the market today. The one-sided multi-display means that the unit when expanded vertically looks like a tablet. The difference is that the one display found on a traditional tablet is two smaller displays on this embodiment, and the device can be folded, locked, and secured. This unit can take advantage of any of the features described herein. Some embodiments can take on the shape of a square, with all sides of the device being of equal size and dimensions (folded or expanded).

In another alternate embodiment, one or more displays appear in a book format where the user can literally turn the page (display) and another page (display) appears. This embodiment would implement back-to-back displays.

An alternate embodiment of the present invention may be implemented as a dual-sided calculator. This embodiment is a powerful computing device with a display and writing device on one side with calculation features along with complex algorithms pre-loaded into the calculator on the other side of the device. The dual-display calculator can be designed any number of ways, using any of the features mentioned. The device can use the traditional calculator keys, use a digital interface, or both, positioned any number of ways.

Another alternate embodiment is a gaming device that uses back-to-back displays including games that use many digital displays simultaneously operating in a connected or disconnected environment. All sizes and shapes are possible. Any of the features described can be used with gaming and educational embodiments.

Another alternate embodiment of the present invention is a medical multi-display computing device. This embodiment is able to view blood and other types of samples on the device by using an adapter or inserting a sample into a slot specifically designed for samples. Imaging technology that mimics microscopes is integrated into this embodiment. Another embodiment is an advanced science microscope with small or large multi-display technology and aspects such as, but not limited to, advanced memory, processors, and on device storage. Advanced analysis software will be available for this embodiment.

Those skilled in the art, in light of the present teaching, will recognize that the multiple display and processor technology described herein may be implemented in a number of other types of devices such as, but not limited to, laptops, desktops, PDAs, electronic organizers, planners, servers, telephones, cameras, camcorders, binoculars, remote controls, televisions, monitors, displays, keyboards, printers, medical devices, CPU boxes, cellular phones, mp3 players, calculators, musical instruments, GPS devices, automobiles, water vehicles, aviation products, video cassette recorders, stereos, DVD/CD players, and home appliances. These devices may apply this technology (multi-display methods or “many to one” method) by enabling them with computing resources and by adding, through any number of means, a processor, memory and a storage area. Advanced applications will most likely use multiple distinct network sessions.

Other devices such as, but not limited to, standard monitors, displays, and televisions can implement the multi-display technology and divide the viewing area accordingly. For example, without limitation, a television with multi-display technology allows the user to watch two or more television programs simultaneously. Analysis software may allow different news stories to be captured, compared, and analyzed. Televisions with multi-display technology optionally have hard disc space, memory, a processor, and internal and/or external storage capability and can connect to many other types of devices.

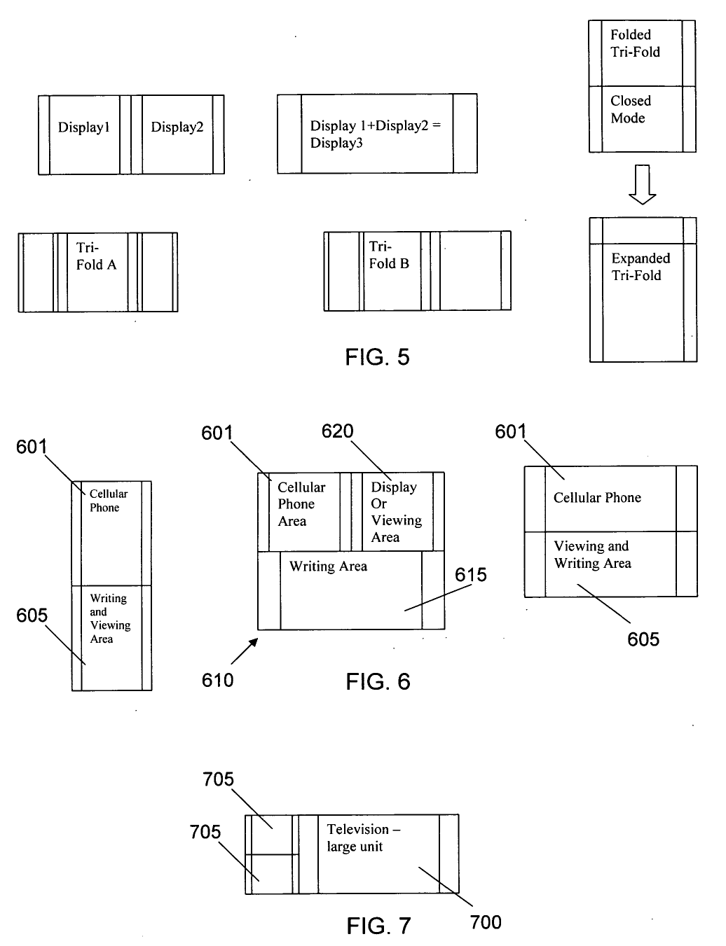

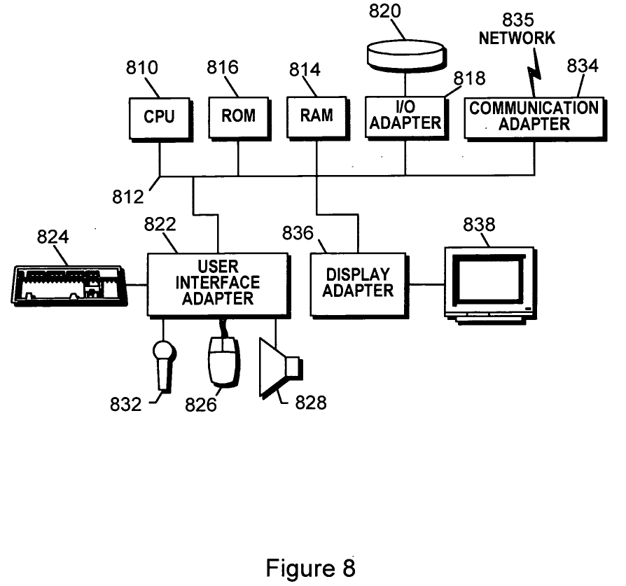

FIG. 7 illustrates an exemplary television 700 implemented with one or more auxiliary viewers 705 or displays, in accordance with an embodiment of the present invention. Auxiliary viewers 705 can optionally be pull-off or pull and go devices. Preferably main television 700 would be larger than auxiliary viewers 705. Auxiliary viewers 705 can be secured and closed off by a door on the television unit. The user has the ability to view different programs or to view the same program on all of the viewers. If enabled by the television station or Cable Company, auxiliary viewers 705 are able to display other clips from the same show. Auxiliary viewers 705 can also have computing technology for applications such as, but not limited to, browsing the Internet, etc. Other information from television stations can be displayed on auxiliary viewers 705, for example, without limitation; television 700 and auxiliary viewers 705 can stream multiple shows simultaneously to the same area. Television 700 can be designed any number of ways, and have any number of additional displays, televisions, or other areas for other types of technologies. Also, a device according to the embodiments described herein may connect to any other electronic enabled device including, but not limited to, telephones, televisions, printers, scanners, copiers, kiosks in the mall, automotive devices, motor vehicles, water vehicles, sports equipment, etc. For example, without limitation, a multi-display device can be connected to a computer monitor, and the user can see information from both computers simultaneously. The multi-display connects using any number of means such as, but not limited to, Ethernet, wireless protocols, standard cable, or USB. In some embodiments files and documents may be placed on the device by placing a flash drive or other media in a drive on another piece of equipment such as, but not limited to, a copier, scanner or printer. Some of the embodiments described herein may also include the feature of being able to play games on the device. FIG. 8 shows a representative hardware environment that may be associated with server computers and/or client computers, in accordance with one embodiment. The present embodiment may be optionally in communication with a remote server network architecture, which may be comprised of, a plurality of networks that may each take any form including, but not limited to a local area network (LAN), a wireless network, a wide area network (WAN) such as the Internet, etc. Typically coupled to the networks are server computers which are capable of communicating over the networks. Also coupled to the networks and the server computers is a plurality of client computers, such as the one shown in the FIG. 8, for example. Such client computers may each include, without limitation, a desktop computer, laptop computer, mobile phone, hand-held computer, personal data assistant (PDA), any component of a computer, and/or any other type of logic. In order to facilitate communication among the networks, at least one gateway or router is optionally coupled therebetween. It should be noted that any of the foregoing components in such a network architecture, as well as any other unillustrated hardware and/or software, may be equipped with various message management features. The FIG. 8 illustrates a typical hardware configuration of a client platform in accordance with one embodiment having at least one central processing unit 810, such as a microprocessor, and a number of other units interconnected via a system bus 812. The client platform shown in FIG. 8 includes a Random Access Memory (RAM) 814; Read Only Memory (ROM) 816; an I/O adapter 818 for connecting peripheral devices such as disk storage units 820 to the bus 812, a user interface adapter 822 for connecting a keyboard 824, a mouse 826, a speaker 828, a microphone 832, and/or other user interface devices such as track balls, touch-sensitive displays, transducer card readers, magnetic or paper tape readers, tablets, styluses, voice or handwriting recognizers, or other well-known input devices such as, of course, other computers (all not shown) to the bus 812; communication adapter 834 for connecting the client platform to a communication network 835 (e.g., communicating, by wired or wireless means, to a data processing network such as the one described above) and a display adapter 836 for connecting the bus 812 to a display device 838. It should be noted that although the FIG. 8 graphically illustrates peripheral components associated with desktop computers, this is only for functionally representational purposes, and those skilled in the art will readily recognize the design and selection of the appropriate components depending upon the needs of the particular application. For example, in handheld client computing platforms, keyboard 824, mouse 826, speaker 828, microphone 832, and display device 838 might all be designed compactly into the hand-held unit and/or some or all may be externally connected thereto. The system shown in the FIG. 8 may include any number of processors 810 (also referred to as central processing units, or CPUs) that are coupled to storage devices including primary storage, typically a random access memory (RAM), or a read only memory (ROM). CPU 810 may be of various types including microcontrollers and microprocessors such as programmable devices (e.g., CPLDs and FPGAs) and unprogrammable devices such as gate array ASICs or general purpose microprocessors. As is well known in the art, a portion of the primary storage may have only a read capability (e.g., a ROM), which acts to transfer data and instructions uni-directionally to the CPU, and another portion of primary storage may have read and write capability (e.g., a RAM), which is used typically to transfer data and instructions in a bi-directional manner. Both of these primary storage devices may include any suitable computer-readable media such as those described above. The mass storage device (e.g., disk storage units 820) are typically coupled bi-directionally via I/O adapter 818 to CPU 810 to provide additional data storage capacity and may include any of the computer-readable media described above. Mass storage device may be used to store programs, data and the like and is typically a secondary storage medium such as a hard disk (e.g., a hard-drive or FLASH drive acting as non-volatile RAM). It will be appreciated that the information retained within the mass storage device, may, in appropriate cases, be incorporated in standard fashion as part of primary storage as virtual memory. A specific mass storage device such as a CD-ROM may also pass data uni-directionally to the CPU 810. Finally, CPU 810 optionally may be coupled to an external device such as a database, a computer, telecommunications, or internet network using an external connection as shown generally at communication network 835. With such a connection, it is contemplated that the CPU 810 might receive information from the network, or might output information to the network in the course of performing the method steps described in the teachings of the present invention.

Having fully described at least one embodiment of the present invention, other equivalent or alternative methods of implementing a digital mobile device with multiple displays, according to the present invention, will be apparent to those skilled in the art. The above description of the present invention is illustrative, and is not intended to be limiting. It will thus be appreciated that various additions, substitutions and modifications may be made to the above described embodiments without departing from the scope of the present invention. The invention is thus to cover all of the modifications, equivalents, and alternatives falling within the spirit and scope of the following claims.

What is claimed is:

1. A handheld electronic device, comprising:
first and second displays;
a first processor configured to be operable for executing a first operating system (OS), said first processor and said electronic device being configured to be operable for displaying said executed first OS on said first display; and
a second processor configured to be operable for executing a second operating system (OS), said second processor and said electronic device being configured to be operable for displaying said executed second OS on said second display.

2. The handheld electronic device of claim 1, in which the execution of said first OS on said first processor is independent of the execution of said second OS on said second processor.

3. The handheld electronic device of claim 1, in which the execution of said first OS on said first processor is at least partially independent of the execution of said second OS on said second processor.

4. The handheld electronic device of claim 1, further comprising:
an instance of said first OS, said electronic devices being configured to execute said first OS on said first processor and display execution of a first graphical user interface (GUI) thereof on said first display; and
an instance of said second OS, said electronic device being configured to execute said second OS on said second processor and display execution of a second GUI thereof on said second display.

5. The handheld electronic device of claim 1, in which said electronic device is adapted to distribute a computational load across said first and second processors.

6. The handheld electronic device of claim 1, in which said electronic device is adapted to utilize said second microprocessor in multitasking operations on one or more programs being executed on said first display when said second display is inactive.

7. The handheld electronic device of claim 1, in which said first and/or second display is a touch-sensitive display.

8. The handheld electronic device of claim 1, further comprising:
a plurality of panel means for providing a structural housing for at least one of said processors and/or at least one of said displays and/or a keyboard; and
means for movably and foldablely joining said plurality of panel means together.

9. The handheld electronic device of claim 8, further comprising:
at least one additional display, which is either configured into at least one of said panel means, or achieved by partitioning said first or second displays into said at least one additional display; and
a plurality of additional processor, each configured to control a respective display and optionally a portion of a common display.

10. The handheld electronic device of claim 9, further comprising means for making at least one of said displays into a display that is comprised as a non-obtrusive part of said electronic device.

11. The handheld electronic device of claim 1, further comprising keyboard means for enabling the alphanumeric data input to said electronic device, said keyboard means being configured with means for making said keyboard means into a keyboard that is comprised as a non-obtrusive part of said electronic device.

12. The handheld electronic device of claim 1, in which said first and second displays are rotateably joined together such that they may be rotated into a back-to-back configuration.

13. The handheld electronic device of claim 1, in which said first and second displays are part of a single display assembly having a front face comprising said first display and a back face comprising said second display.

14. The handheld electronic device of claim 1, further comprising software code stored on a storage medium which causes one of said processors to display on a first portion each of said displays common content, and display content in second portion said second display that is not displayed in said first display.

15. The handheld electronic device of claim 1, in which said electronic device is configured to be capable of coordinating at least some of said displays to act as units of a single, larger display in the rendering displayed images.

16. The handheld electronic device of claim 1, further comprising computing system and display means for generating and displaying images on a plurality of displays.

17. The handheld electronic device of claim 1, further comprising means for a user to input data to said handheld electronic device and/or to interact with at least said first and/or second GUI.

18. A method of displaying images on a portable electronic device having a plurality of displays, the method comprising:
Steps for generating images to be displayed on at least some of said plurality of displays; and
Steps for displaying and coordinating images displayed on at least some of said plurality of displays.

19. A computing system having a plurality of displays, the system comprising:
processing means for executing at least one operating system and/or associated software application(s);
means for generating images for display on a plurality of displays;
display means for displaying on a plurality of displays images generated by said image generating means; and
means for a user to input data to said computing system and/or to interact with said at least one operating system and/or associated software application(s).

20. The computing system of claim 1 9, further comprising:
a plurality of panel means for providing a structural housing for said processor means and/or said display means and/or said data input means; and
means for movably and foldablely joining said plurality of panel means together.
